(19) United States
(12) Patent Application Publication
(10) Pub. No.: US 2009/0022411 A1
(43) Pub. Date: Jan. 22, 2009

(54) IMAGE DISPLAY APPARATUS

(75) Inventors: Masutaka INOUE, Hirakata-City (JP); Susumu Tanase, Kadoma-City (JP); Yoshinao Hiranuma, Hirakata-City (JP); Takaaki Abe, Osaka-City (JP); Masahiro Haraguchi, Daito-City (JP)

Correspondence Address: MOTS LAW, PLLC, 1629 K STREET N.W., SUITE 602, WASHINGTON, DC, 20006, US

(73) Assignee: SANYO ELECTRIC CO., LTD., Moriguchi-City (JP)

(21) Appl. No.: 12/175,668

(22) Filed: Jul. 18, 2008

(30) Foreign Application Priority Data
Jul. 20, 2007 (JP) JP2007-189909

(51) Int. Cl. G06K 9/46

(52) U.S. Cl. 382/239

(57) ABSTRACT

An image display apparatus 100 comprises: a low-luminance frame generator 230 configured to generate a low-luminance frame in which a luminance of an original frame corresponding to an image input signal is decreased; a motion-compensated frame generator 240 configured to generate a motion-compensated frame in which a motion of an object included in the original frame is compensated; a combining ratio changer 250 configured to change a combining ratio between the low-luminance frame and the motion-compensated frame according to an image characteristic obtained based on the image input signal; a combiner 260 configured to generate a combining frame by combining the low-luminance frame and the motion-compensated frame; and an output signal unit 270 configured to insert the combining frame between continuous original frames.

### CROSS REFERENCE TO RELATED APPLICATIONS

This application is based upon and claims the benefit f priority from prior Japanese Patent Application No. 2007-189909, filed on Jul. 20, 2007; the entire contents of which are incorporated herein by reference.

### BACKGROUND OF THE INVENTION

1. Field of the Invention

The present invention relates to an image display apparatus which converts a first frame rate corresponding to an image input signal to a second frame rate higher than the first frame rate.

2. Description of the Related Art

A techniques for converting an original frame rate (a first frame rate) which corresponds to an image input signal to a frame rate (a second frame rate) which is n times as fast as the original frame rate have been heretofore known. This conversion is performed by dividing a frame period into multiple divisional frame periods and then by displaying an image frame for each of the multiple divisional frame periods. Here, the techniques for generating an image frame displayed for each of the multiple divisional frame periods include (1) a black insertion technique and (2) a frame interpolation technique.

In (1) the black insertion technique, a low-luminance frame (a black display frame), in which a luminance of an original frame is decreased, is generated. Subsequently, the low-luminance frame is inserted between continuous original frames. (see Japanese Patent Application Publication No. 2006-259619, paragraphs [0047] to [0049], for example)

In (2) the frame interpolation technique, after estimating a motion vector and the like based on the nth original frame and the n+1th original frame, a motion-compensated frame, in which a motion of an object between the continuous original frames is compensated based on the motion vector and the like, is generated. Subsequently, the motion-compensated frame is inserted between continuous original frames.

According to the black insertion technique and the frame interpolation technique, it is possible to prevent moving images from blurring in hold displays.

Thus, in the black insertion technique, it is possible to prevent moving images from blurring. However, the black insertion technique causes a decrease of the luminance in one frame period, because the low-luminance frame is inserted between the continuous original frames.

In the frame interpolation technique, it is necessary to generate motion-compensated frames with high precision in order to effectively prevent moving images from blurring. Consequently, when preventing moving images from blurring by using only the frame interpolation technique, it causes increases of the process load and circuit size needed to generate motion-compensated frames.

### SUMMARY OF THE INVENTION

An aspect of the present invention provides an image display apparatus which converts a first frame rate corresponding to an image input signal to a second frame rate higher than the first frame rate. The image display apparatus comprises: a first generator (a low-luminance frame generator 230) configured to generate a low-luminance frame in which a luminance of the original frame corresponding to an image input signal is decreased; a second generator (a motion-compensated frame generator 240) configured to generate a motion-compensated frame in which a motion of an object included in the original frame is compensated; a combiner (a combining ratio changer 250 and a combiner 260) configured to generate a combining frame by combining the low-luminance frame and the motion-compensated frame; and an inserter (an output signal unit 270) configured to insert the combining frame between continuous original frames, wherein the combiner is configured to change a combining ratio between the low-luminance frame and the motion-compensated frame according to an image characteristic obtained based on the image input signal.

According to the aspect, the combining frame is generated by combining the low-luminance frame and the motion-compensated frame. Consequently, it is possible to prevent the decrease of the luminance of the original fame, compared to a case where the original frame is interpolated by using only the low-luminance frame. On the other hand, it is possible to reduce the process load and circuit size needed to generate the motion-compensated frame, compared to a case where the original frame is interpolated by using only the motion-compensated frame.

In addition, the combiner changes the combining ratio between the low-luminance frame and the motion-compensated frame according to the image characteristic obtained based on the image input signal. Consequently, it is possible to appropriately prevent moving images from blurring.

In the above-described aspect of the present invention, the combiner is preferably configured to change the combining ratio for each of a plurality of unit areas constituting a frame.

In the above-described aspect of the present invention, the image characteristic is preferably a luminance obtained based on the image input signal, and the combiner is preferably configured to increase a contribution degree of the motion-compensated frame as the luminance increases.

In the above-described aspect of the present invention, the image characteristic is preferably a saturation obtained based on the image input signal, and the combiner is preferably configured to change the combining ratio according to the saturation.

In the above-described aspect of the present invention, the image characteristic is preferably a hue obtained based on the image input signal, and the combiner is preferably configured to change the combining ratio according to a visibility of the hue.

In the above-described aspect of the present invention, the image characteristic is preferably a motion amount obtained based on the image input signal, and the combiner is preferably configured to increase a contribution degree of the motion-compensated frame as the motion amount increases.

In the above-described aspect of the present invention, the image characteristic is preferably an edge amount of each of the plurality of unit areas obtained based on the image input signal, and the combiner is preferably configured to increase a contribution degree of the motion-compensated frame in each of the plurality of unit areas as the edge amount of each of the plurality of unit areas increases.

### BRIEF DESCRIPTION OF THE DRAWINGS

FIG. 1 is a diagram showing a configuration of an image display apparatus 100 according to a first embodiment of the present invention.

FIG. 2 is a block diagram showing a configuration of a signal processor 200 according to the first embodiment.

FIG. 3 is a diagram showing an example of how to generate a low-luminance frame according to the first embodiment.

FIG. 4 is a block diagram showing a configuration of a motion-compensated frame generator 240 according to the first embodiment.

FIG. 5 is a diagram showing an example of how to generate a motion-compensated frame according to the first embodiment.

FIG. 6 is a diagram showing a combining ratio between the low-luminance frame and the motion-compensated frame according to the first embodiment.

FIG. 7 is a diagram showing an example of how to generate a low-luminance frame according to a second embodiment of the present invention.

### DETAILED DESCRIPTION OF THE PREFERRED EMBODIMENTS

An image display apparatus according to embodiments of the present invention will be described below with reference to the drawings. In the descriptions of the drawings, identical or similar reference numerals are given to identical or similar parts.

It should, however, be noted that the drawings are schematic and that the proportions among various dimensions differ from the actual ones. Accordingly, specific dimensions have to be judged by taking account of the descriptions given below. In addition, note that dimensional relations or the proportions among various drawings may differ from one drawing to another.

### First Embodiment

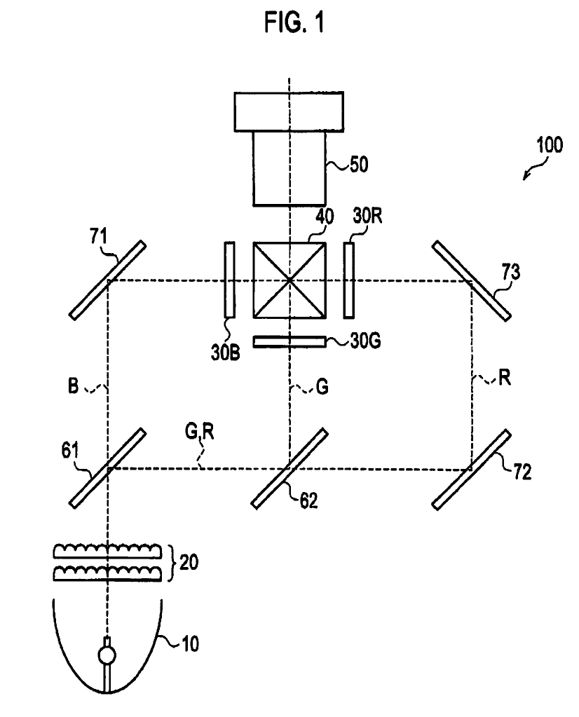

A configuration of an image display apparatus according to a first embodiment of the present invention will be described below with reference to the drawings. FIG. 1 is a diagram showing an image display apparatus 100 according to the first embodiment.

As shown in FIG. 1, the image display apparatus 100 includes a light source 10, a fly-eye lens unit 20, multiple liquid crystal panels (a liquid crystal panel 30R, a liquid crystal panel 30G and a crystal panel 30B), a cross dichroic prism 40 and a projection lens unit 50.

The light source 10 emits a white light including a red component light R, a green component light G and a blue component light B. Examples of the light source 10 include a UHP lamp emitting the white light.

The fly-eye lens unit 20 is an optical element for equalizing the white light emitted from the light source 10. Specifically speaking, the fly-eye lens unit 20 is configured of paired fly-eye lenses, and each of the fly-eye lenses is configured of multiple micro-lenses.

The liquid crystal panel 30R is an optical element for modulating the red component light R according to an image output signal (a red output signal R). The liquid crystal panel 30G is an optical element for modulating the green component light G according to an image output signal (a green output signal G). The liquid crystal panel 30B is an optical element for modulating the blue component light B according to an image output signal (a blue output signal B).

The cross dichroic prism 40 combines color component lights emitted from the respective liquid crystal panels 30, and emits a combining light of the color component lights to the projection lens unit 50.

The projection lens unit 50 projects the combining light (image light) emitted from the cross-dichroic prism 40 to a screen (not illustrated).

In addition, the image display apparatus 100 further includes a dichroic mirror 61, a dichroic mirror 62, a reflecting mirror 71, a reflecting mirror 72 and a reflecting mirror 78.

The dichroic mirror 61 is a color separating element which transmits the blue component light B, and which reflects the red component light R and the green component light G. The dichroic mirror 62 is a color separating element which transmits the red component light R, and which reflects the green component light G.

The reflecting mirror 71 reflects the blue component light B, and leads the blue component light B to the liquid crystal panel 30B. The reflecting mirror 72 and the reflecting mirror 78 reflects the red component light R, and leads the red component light R to the liquid crystal panel 30R.

### (Configuration of Signal Processor)

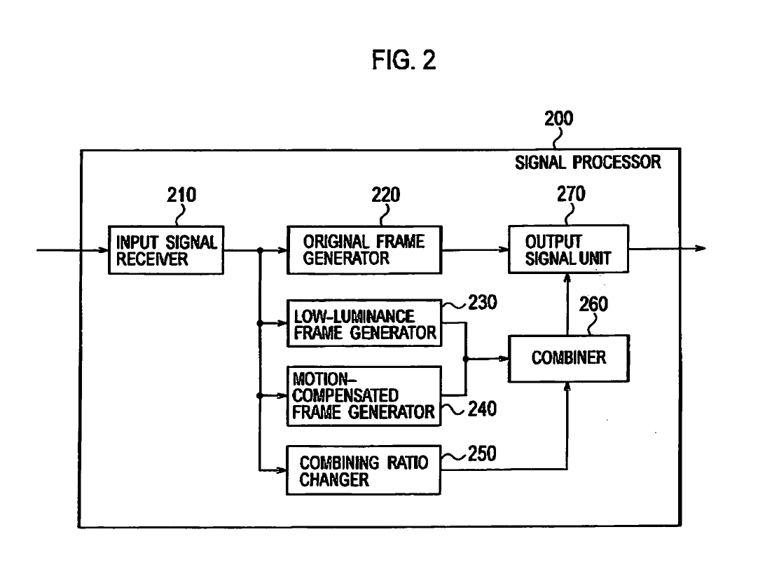

A configuration of a signal processor according to the first embodiment of the present invention will be described below with reference to the drawings. FIG. 2 is a block diagram showing a configuration of the signal processor 200 according to the first embodiment. The signal processor 200 is provided in the image display apparatus 100.

The signal processor 200 converts an original frame rate (a first frame rate) corresponding to an image input signal to a frame rate (a second frame rate) that is n times as fast as the original frame rate. This conversion is performed by dividing a frame period into multiple divisional frame periods and then by displaying an image frame for each of the multiple divisional frame periods. In the first embodiment, an example where the signal processor 200 converts an original frame rate to a double-speed frame rate will be described.

Specifically, the signal processor 200 alternately outputs an original frame and a combining frame generated based on the original frame. As described later, the combining frame is a frame obtained by combining a low-luminance frame in which a luminance of the original frame is decreased and a motion-compensated frame in which a motion of an object included in the original frame is compensated.

As shown in FIG. 2, the signal processor 200 includes an input signal receiver 210, an original frame generator 220, a low-luminance frame generator 230, a motion-compensated frame generator 240, a combining rate changer 250, a combiner 260, and an output signal unit 270.

The input signal receiver 210 obtains an image input signal (a red input signal R, a green input signal G and a blue input signal B) from a DVD playback apparatus, a TV tuner or the like.

The original frame generator 220 generates an original frame based on the image input signal (a red input signal R, a green input signal G and a blue input signal B). Specifically, the original frame generator 220 converts the image input signal (a red input signal B, a green input signal G and a blue input signal B) to an image output signal (a red output signal R, a green output signal G and a blue output signal B). Subsequently, the original frame generator 220 outputs the image output signal corresponding to the original frame to the outputer 270.

The original frame generator 220 includes, for example, a y-correction circuit, a delay circuit (a buffer) configured to synchronize the original frame and the combining frame.

The low-luminance frame generator 230 generates a low-luminance frame in which the luminance of the original frame is decreased. Specifically speaking, the low-luminance frame generator 230 generates an image signal corresponding to the low-luminance frame, based on the image input signal (a red input signal R, a green input signal G and a blue input signal B) corresponding to the nth (or the n+1th) original frame, and thus outputs the image signal corresponding to the low-luminance frame to the combiner 260. Here, the low-luminance frame is used to generate a combining frame to be inserted between the nth original frame and the n+1th original frame.

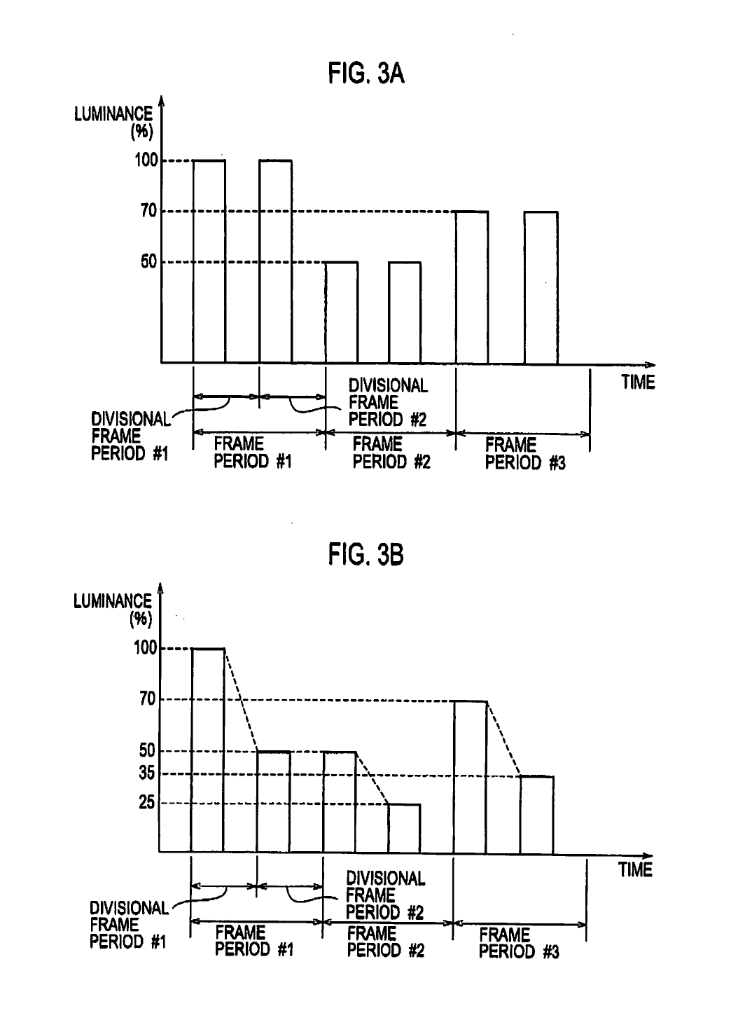

Suppose, for example, that an original frame (a frame corresponding to the divisional frame #1) has the luminance as shown in FIGS. 3A and 3B. FIG. 3A shows a general method of generating a frame. FIG. 3B shows a method of generating a frame (a low-luminance frame) used in the first embodiment.

Generally, as shown in FIG. 3A, an original frame (a frame corresponding to the divisional frame #1) is just copied, and thereby a frame corresponding to the divisional frame #2 is generated.

On the other hand, in the first embodiment, as shown in FIG. 3B, the low-luminance frame generator 230 generates a low-luminance frame (a frame corresponding to the divisional frame #2) in which the luminance of the original frame is decreased.

It should be noted that FIG. 3B shows a case where the luminance of the low-luminance frame is half of the luminance of the original frame. For example, in the frame period #1, a luminance of an original frame corresponding to the divisional frame #1 is 100%, whereas the luminance of a low-luminance frame corresponding to the divisional frame #2 is 50%. Similarly, in the frame period #2, the luminance of an original frame corresponding to the divisional frame #1 is 50%, whereas the luminance of a low-luminance frame corresponding to the divisional frame #2 is 25%. In the frame period #3, the luminance of an original frame corresponding to the divisional frame #1 is 70%, whereas the luminance of a low-luminanoe frame corresponding to the divisional frame #2 is 35%.

The motion-compensated frame generator 240 generates a motion-compensated frame in which a motion of an object included in the continuous original frames is compensated. Specifically speaking, the motion-compensated frame generator 240 generates an image signal corresponding to the motion-compensated frame based on image input signals (each including a red input signal R, a green input signal G and a blue input signal B) respectively corresponding to the nth original frame and the n+1th original frame, and thus outputs the image signal corresponding to the motion-compensated frame to the combiner 260. It should be noted that the motion-compensated frame is used to generate a combining frame inserted between the nth original frame and the n+1th original frame.

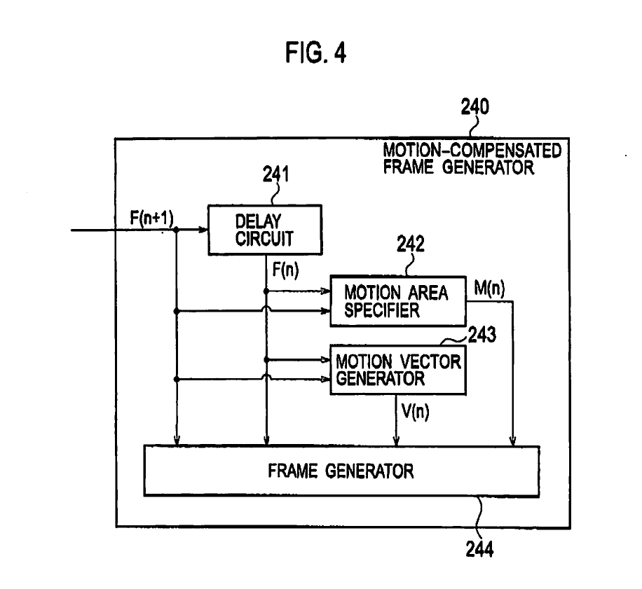

For example, the motion-compensated frame generator 240 includes a delay circuit 241, a motion area specifier 242, a motion vector generator 243 and a frame generator 244, as shown in FIG. 4.

By using FIG. 4, a method of generating a motion-compensated frame used to generate a combining frame inserted between the nth original frame and the n+1th original frame will be described. Specifically, descriptions will be provided for how a motion-compensated frame is generated in a case where an image signal (F(n+1)) corresponding to the n+1th original frame is inputted in the motion-compensated frame generator 240.

The delay circuit 241 is a circuit configured to delay an image input signal corresponding to an original frame. Specifically speaking, the delay circuit 241 delays an image input signal (F(n)) corresponding to the nth original frame, and thus outputs the resultant image input signal (F(n)).

The motion area specifier 242 specifies a motion area (M(n)) including an object which moves between the nth original frame and the n+1th original frame based on the image input signal (F(n)) and the image input signal (F(n+1)).

The motion vector generator 243 calculates a motion vector (V(n)) of the object which moves between the nth original frame and the n+1th original frame, based on the image input signal (F(n)) and the image input signal (F(n+1)). Incidentally, any one of existing calculation methods such as a dot matching method and a block matching method for each block can be used as the method of calculating the motion vector (V(n)).

For the motion area (M(n)) specified by the motion area specifier 242, the frame generator 244 generates part of a motion-compensated frame according to the motion vector (V(n)) calculated by the motion vector generator 243, the part corresponding to the motion area M(n)). In addition, for an area other than the motion area (M(n)) specified by the motion area specifier 242 (that is, for a static area), the frame generator 244 generates the other part of the motion-compensated frame based on the image input signal (F(n)) or the image input signal (F(n+1)), the other part corresponding to the stationary area.

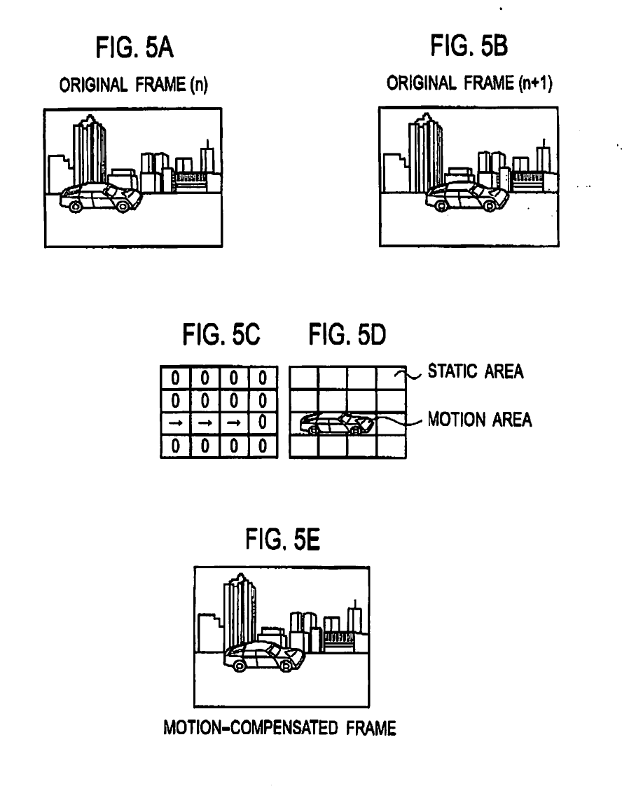

Suppose, for example, that a motion-compensated frame is going to be generated in a case where the nth original frame is a frame as shown in FIG. 5A whereas the n+1th original frame is a frame as shown in FIG. 5B.

As shown in FIG. 5C, the motion vector generator 243 calculates the motion vector (V(n)) based on the nth original frame and the n+1th original frame.

As shown in FIG. 5D, the motion area specifier 242 specifies the motion area (M(n)) based on the nth original frame and the n+1th original frame.

As shown in FIG. 5E, the frame generator 244 generates a motion compensated frame which the motion of the object included in the continuous original frames is compensated.

As shown in FIG. 2, the combining ratio changer 250 acquires an image characteristic of the original frame based on the image input signal (the red input signal R, the green input signal G and the blue input signal B). Subsequently, the combining ratio changer 250 changes the combining ratio between the low-luminance frame and the motion-compensated frame based on the image characteristic of the original frame.

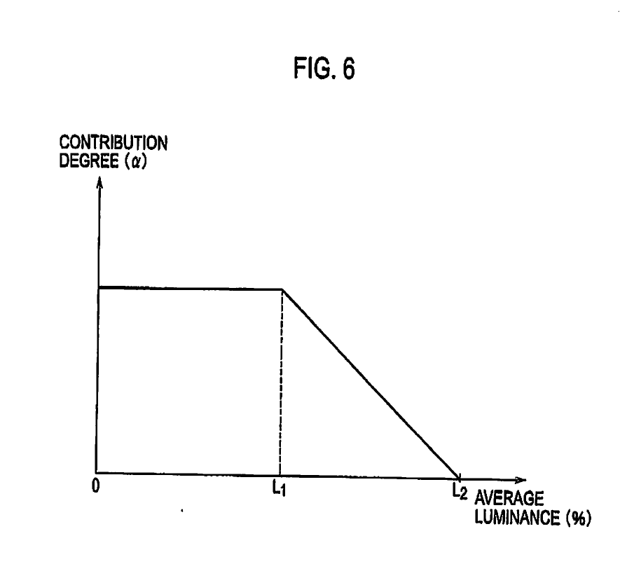

For example, the combining ratio changer 250 acquires an average luminance of the nth (or n+1th) original frame, and changes the combining ratio according to the average luminance, as shown in FIG. 6. In FIG. 6, the vertical axis represents a contribution degree (α) of the low-luminance frame to the combining frame, and the horizontal axis represents the average luminance of the nth (or n+1th) original frame.

As shown in FIG. 6, the contribution degree (α) of the low-luminance frame is constant in a range where the average luminance of the original frame is 0 to L₁ (for example, L₁ is equal to 50%). In a range where the average luminance of the original frame is L₁ to L₂ (for example, L₂ is equal to 100%), the contribution degree (α) of the low-luminance frame decreases as the average luminance of the original frame increases.

Specifically speaking, in the range where the average luminance of the original frame is 0 to L₁, the contribution degree (1-α) of the motion-compensated frame is constant. In the range where the average luminance of the original frame is L₁ to L₂, the contribution degree (1-α) of the motion-compensated frame increases as the average luminance of the original frame increases.

The combiner 260 generates a combining frame by combining the low-luminance frame and the motion-compensated frame according to the combining ratio changed by the combining ratio changer 250. The combiner 260 combines the image signals respectively corresponding to the low-luminance frame and the motion-compensated frame according to the combining ratio, and thus generates an image output signal (a red output signal R, a green output signal G and a blue output signal B) corresponding to a combining frame. Subsequently, the combiner 260 outputs the image output signal corresponding to the combining frame to the outputer 270.

The outputer 270 outputs the image output signals (the red output signal R, the green output signal G and the blue output signal B) respectively corresponding to the original frame and the combining frame. Specifically speaking, the outputer 270 outputs the red output signals R to the liquid crystal panel 30R, the green output signals G to the liquid crystal panel 30G, and the blue output signals B to the liquid crystal panel 30B.

### (Action/Working-Effect)

According to the first embodiment, the combining frame is generated by combining the low-luminance frame and the motion-compensated frame. Consequently, it is possible to prevent the decrease of the luminance of the original frame, compared to a case where the original frame is interpolated by using only the low-luminance frame. On the other hand, it is possible to reduce the process load and circuit size needed to generate the motion-compensated frame, compared to a case where the original frame is interpolated by using only the motion-compensated frame.

In addition, the combining ratio changer 250 changes the combining ratio between the low-luminance frame and the motion-compensated frame according to the image characteristic obtained based on the image input signal. Consequently, it is possible to appropriately prevent moving images from blurring due to the motion of the object included in the continuous original frames

Specifically speaking, in the first embodiment, the combining ratio changer 250 increases the contribution degree of the motion-compensated frame, and decreases the contribution degree of the low-luminance frame, as the luminance obtained based on the image input signal increases. Therefore, it is possible to prevent moving images from blurring while preventing the decrease of the luminance in a frame period.

### Second Embodiment

A second embodiment by referring to the drawings will be described will be described below with reference to the drawings. The descriptions given below are focused mainly on the difference between the above-described first embodiment and the second embodiment.

Specifically speaking, in the first embodiment, the low-luminance frame generator 320 generates the low-luminance frame in which the luminance of the original frame is simply decreased (see FIG. 3).

In contrast, in the second embodiment, the low-luminance frame generator 230 generates a low-luminance frame by using a luminance collection method. In the luminance collection method, the luminance in a divisional frame #2 is collected in a divisional frame #1 when the luminance through a frame period is constant.

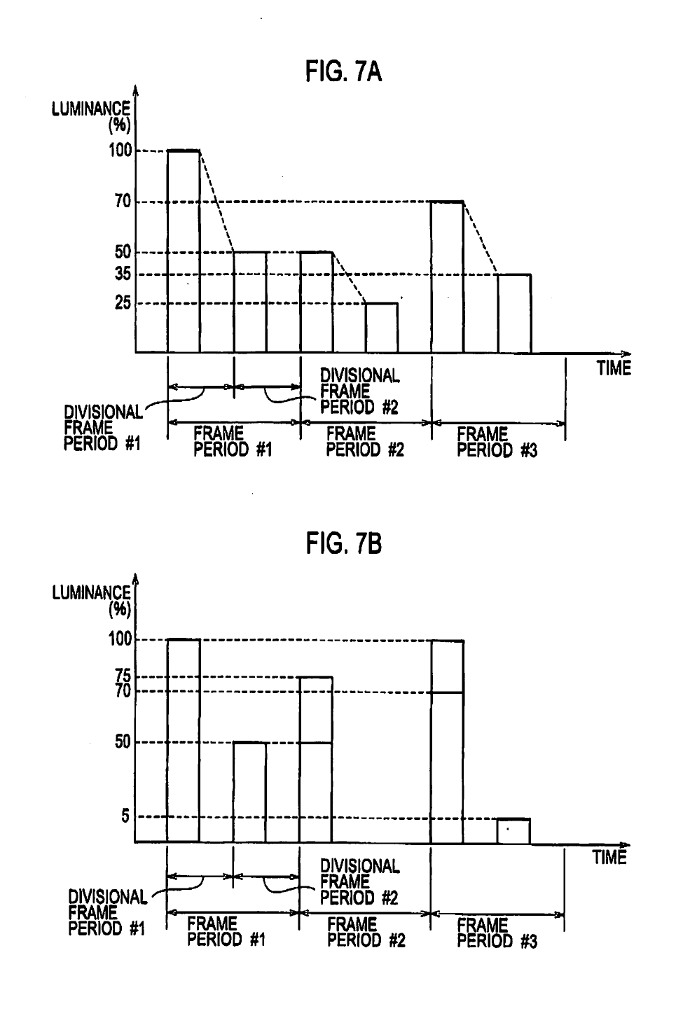

Suppose, for example, that an original frame (a frame corresponding to the divisional frame #1) has a luminance as shown in FIGS. 7A and 7B as in the case of the luminance as shown in FIGS. 3A and 3B. FIG. 7A shows the method of generating a low-luminance frame according to the first embodiment. FIG. 7A shows the method of generating et low-luminance frame according to the second embodiment.

In the first embodiment, as shown in FIG. 7A, the low-luminance frame, in which the luminance of the original frame is simply decreased, is generated in a manner shown in FIG. 3B.

In contrast, in the second embodiment, as shown in FIG. 7B, the low-luminance frame generator 230 adds the luminance in a divisional frame #2 in FIG. 7A to the luminance in a divisional frame #1.

For example, in the frame period #1, the luminance in the original frame corresponding to the divisional frame #1 is 100%. As a result, no luminance in the divisional frame #2 can be added any more to the luminance in the divisional frame #1. For this reason, the luminance in the low-luminance frame corresponding to the divisional frame #2 is 50%, like FIG. 7A.

On the other hand, in the frame period #2, the luminance in the original frame corresponding to the divisional frame #1 is 75%, whereas the luminance in the low-luminance frame corresponding to the divisional frame #2 is 0%. Specifically speaking, the luminance (25%) assigned to the divisional frame #2 in FIG. 7A is collected in the divisional frame #1.

In the frame period #3, the luminance in the original frame corresponding to the divisional frame #1 is 100%, whereas the luminance in the low-luminance frame corresponding to the divisional frame #2 is 5%. Specifically speaking, out of the luminance (35%) assigned to the divisional frame #2 in FIG. 7A, the luminance (30%) is collected in the divisional frame #1.

It should be noted that the combiner 260 may combine: the original frame corresponding to the divisional frame #1 after the luminance collection; and the original frame corresponding to the divisional frame #1 before the luminance collection. As the combining ration in such a case, the combining ratio used for the divisional frame #2 may be used. For example, the contribution degree of the original frame corresponding to the divisional frame #1 after the luminance collection may be set to “α” (that is, the contribution degree of the low-luminance frame), and the contribution degree of the original frame corresponding to the divisional frame #1 before the luminance collection may be set to “1-α” (that is, the contribution degree of the motion-compensated frame).

### (Action/Working-Effect)

According to the second embodiment, the luminance is collected in the divisional frame period #1 by the luminance collection method. Consequently, it is possible to prevent the decrease of the luminance in consideration of the visibility. Meanwhile, a low-luminance frame (that is, the combining frame generated by using the low-luminance frame) is inserted between continuous original frames in the divisional frame period #2. Consequently it is possible to prevent blurring of moving images due to the motion of the object included in the continuous original frames.

### Third Embodiment

A third embodiment by referring to the drawings will be described will be described below with reference to the drawings. The descriptions given below are focused mainly on the difference between the above-described first embodiment and the third embodiment.

Specifically speaking, in the first embodiment, the combining ratio changer 250 changes the combining ratio between the low-luminance frame and the motion-compensated frame according to the average luminance (an image characteristic) of the nth (or n+1th) original frame.

By contrast, in the third embodiment, the combining ratio changer 250 may change the combining ratio between the low-luminance frame and the motion compensated frame according to the saturation (an image characteristic) of the nth (or n+1th) original frame.

The combining ratio changer 250 may change the combining ratio between the low-luminance frame and the motion-compensated frame according to the hue (an image characteristic) of the nth (or n+1th) original frame.

The combining ratio changer 250 may change the combining ratio between the low-luminance frame and the motion-compensated frame according to the motion amount (an image characteristic) between the nth original frame and the n+1th original frame. Specifically speaking, the combining ratio changer 250 decreases the contribution degree (α) of the low-luminance frame, and increases the contribution degree (1-α) of the motion-compensated frame, as the motion amount increases. Consequently, it is possible to prevent blurring of moving images due to the motion of the object included in continuous original frames.

The combining ratio changer 250 may change the combining ratio between the low-luminance frame and the motion-compensated frame for each of a plurality of unit areas constituting the nth (or n+1th) original frame, according to the edge amount for each of the plurality of unit areas. Specifically speaking, the combining ratio changer 250 decreases the contribution degree (α) of the low-luminance frame, and increases the contribution degree (1-α) of the motion-compensated frame, as the edge amount increases. Consequently it is possible to effectively prevent blurring of moving images due to the motion of the object included in continuous original frames.

It should be noted that the edge amount is represented by an integrated value of the horizontal differential and the vertical differential of pixel values of respective pixels included in each unit area, or by an integrated value of values obtained after the bypass filter is applied to pixel values of the respective pixels included in each unit area.

### Other Embodiment

The present invention has been described based on the foregoing embodiments. The descriptions and drawings that constitute this disclosure of the present invention shall not be construed as imposing an restrictions on the present invention. From this disclosure, various alternative embodiments, examples and application technologies will be clear to those skilled in the art.

For example, the combining ratio changer 250 may uniformly change the combining ratio between the low-luminance frame and the motion-compensated frame throughout all of the areas in an original frame, although no specific descriptions have been provided for this scheme with respect to the foregoing embodiments. Otherwise, the combining ratio changer 250 may change the combining ratio between the low-luminance frame and the motion-compensated frame individually for each of the plurality of unit area constituting the original frame.

In the foregoing embodiments, the low-luminance frame is generated by decreasing the luminance of the original frame. However, the method of generating the low-luminance frame is not limited to this scheme. Instead, the low-luminance frame may be generated by decreasing the luminance of the motion compensated frame generated based on the original frame.

The combining ratio changer 250 may change the combining ratio between the low-luminance frame and the motion-compensated frame by combining two or more of the multiple image characteristics (including the luminance, the saturation, the hue, the motion amount and the edge amount, although no specific descriptions have been provided for this scheme with respect to the foregoing embodiments.

What is claimed is:

1. An image display apparatus which converts a first frame rate corresponding to an image input signal to a second frame rate higher than the first frame rate, comprising:
a first generator configured to generate a low-luminance frame in which a luminance of an original frame corresponding to the image input signal is decreased;
a second generator configured to generate a motion-compensated frame in which a motion of an object included in the original frame is compensated;
a combiner configured to generate a combining frame by combining the low-luminance frame and the motion-compensated frame; and
an inserter configured to insert the combining frame between continuous original frames, wherein
the combiner is configured to change a combining ratio between the low-luminance frame and the motion-compensated frame according to an image characteristic obtained based on the image input signal.

2. The image display apparatus according to claim 1, wherein
the combiner is configured to change the combining ratio for each of a plurality of unit areas constituting a frame.

3. The image display apparatus according to claim 1, wherein
the image characteristic is a luminance obtained based on the image input signal, and
the combiner is configured to increase a contribution degree of the motion-compensated frame as the luminance increases.

4. The image display apparatus according to claim 1, wherein
the image characteristic is a saturation obtained based on the image input signal, and
the combiner is configured to change the combining ratio according to the saturation.

5. The image display apparatus according to claim 1, wherein
the image characteristic is a hue obtained based on the image input signal, and
the combiner is configured to change the combining ratio according to a visibility of the hue.

6. The image display apparatus according to claim 1, wherein
the image characteristic is a motion amount obtained based on the image input signal, and
the combiner is configured to increase a contribution degree of the motion-compensated frame as the motion amount increases.

7. The image display apparatus according to claim 2, wherein
the image characteristic is an edge amount of each of the plurality of unit areas obtained based on the image input signal, and
the combiner is configured to increase a contribution degree of the motion-compensated frame in each of the plurality of unit areas as the edge amount of each of the plurality of unit areas increases.
